(19) United States
(12) Patent Application Publication
(10) Pub. No.: US 2020/0375169 A1
(43) Pub. Date: Dec. 3, 2020

(54) Insect Trap

(71) Applicant: NINGBO DAYANG TECHNOLOGY CO., LTD., Ningbo (CN)

(72) Inventors: JUN ZHENG, NINGBO (CN); YUANAI NING, NINGBO (CN)

(73) Assignee: NINGBO DAYANG TECHNOLOGY CO., LTD.

(21) Appl. No.: 16/600,474

(22) Filed: Oct. 12, 2019

(30) Foreign Application Priority Data
May 31, 2019 (CN) 201910466531.2

(51) Int. Cl. A01M 1/10; A01M 1/02; A01M 1/14

(52) U.S. Cl. CPC A01M 1/10; A01M 1/14; A01M 1/02

(57) ABSTRACT

The present disclosure discloses an insect trap, comprising a trap and a trapping box having an opening at the upper end; the trapping box is internally provided with a killing component wherein the trapping box is mounted underneath the trap and the bottom of the trapping box is connected to the trap; a space for insects to pass through is reserved between the trap and the upper edge of the trapping box. The insect trap lures insects around the trap into the trapping box and further effectively prevent the insects from climbing onto the trap.

### CROSS-REFERENCE TO RELATED APPLICATIONS

This application claims priority to Chinese Patent Application No. 201910466531.2 with a filing date of May 31, 2019. The content of the aforementioned applications, including any intervening amendments thereto, are incorporated herein by reference.

### TECHNICAL FIELD

The present invention relates to the technical field of pest control, and particularly relates to an insect trap.

### BACKGROUND OF THE INVENTION

Bedbugs, small nocturnal insects of Cimicidae family, live on blood of humans and other warm-blooded hosts. Detection and control of the bedbugs are extremely difficult and time-consuming due to their mysterious behaviors. It is particularly so for common bedbugs (i.e., Cimex lectularius) which have greatly adapted to the human environment. Other types of bedbugs, for example, Cimex hemipterus cause nuisance to people and/or animals as well. Although bedbugs have been under control in many countries and regions, such as the United States of America, they resurge as a result of explosion of tourism around the world in recent years. What's worse, dependent on their intrinsic features, bedbugs will be difficult to eradicate once found in some place. Thus, an effective insect killer, which may position and kill the bedbugs effectively before they are out of control is urgently needed.

An insect trap generally comprises a trap and a trapping box. In the prior art, the trapping box of the insect trap is often mounted at the inner side of the trap, a through hole for the insects to climb into the trap is formed in the shell of the trap; or the outer side wall of the trapping box is connected to the outer side wall of the trap. However, the abovementioned structure has the following defects: the trapping box is mounted at the inner side of the trap or the outer side wall of the trapping box connected to the outer side wall of the trap, in which case, the insects moving around the insect trap may climb onto the trap while avoiding the trapping box, so that leads to a poor insect trapping effect.

### SUMMARY

The technical problem to be solved by this present disclosure is to provide an insect trap, which is able to lure insects around the trap into the trapping box and further effectively prevent the insects from climbing onto the trap.

The insect trap provided by the technical solution of the present disclosure structurally comprises a trap and a trapping box having an opening at the upper end; the trapping box is internally provided with a killing component; the trapping box is mounted underneath the trap; the bottom of the trapping box is connected to the trap; and space for insects to pass through is reserved between the trap and the upper edge of the trapping box.

With the abovementioned structure, the insect trap of the present disclosure has the following advantages as compared with the prior art:

Since the bottom of the trapping box of the insect trap of the present disclosure is connected to the trap, the space for insects to pass through is reserved between the trap and the upper edge of the trapping box, and the side wall of the trapping box is not connected with the trap, insects have no choice but to climb into the trapping box when climbing upward along the trapping box, instead of climbing onto the trap. Therefore, it will succeed in luring the insects around the trap into the trapping box and effectively present the insects from climbing onto the trap.

In one embodiment, a connecting piece of the height exceeding the height of the trapping box is provided on the inner wall of the bottom of trapping box. The connecting piece is detachably connected to the lower surface of the trap. With the abovementioned structure, the trap is elevated by the connecting piece so as to broaden the distance between the trap and the trapping box.

In one embodiment, the upper end surfaces of the connecting piece and the lower surface of the trap are clamped by means of a groove and a bulge. By adopting the above arrangement, the structure is simple, and assembly convenient.

In one embodiment, the upper end surface of the connecting piece is provided with the said groove and the lower surface of the trap is provided with the said bulge, which embodies the optimal design scheme.

In one embodiment, the groove is internally provided with a first adsorptive piece that can be an iron piece or a magnet; the bulge is provided with a second adsorptive piece that can be a magnet or an iron piece; the bulge is clamped into the groove and the first and second adsorptive pieces attract. With the abovementioned structure, the connection between the connecting pieces and the trap is more reliable.

In one embodiment, the groove bottom of the groove is fixedly connected with a bolt, and the lower surface of the bulge is fixedly connected with a magnet. By adopting the above arrangement, the structure is simple, and assembly convenient.

In one embodiment, the bottom of the trapping box is provided with a circle of closed division plate that divides the trapping box into an interior area and an exterior area; the interior area is provided with an adhesive and the inner surface of the side wall of the trapping box is arrange with a smoothing agent. With the abovementioned structure, insects will be prevented from climbing out of the trapping box through its side wall under the effect of the smoothing agent on the inner surface of the side wall of the trapping box when they climb into the trapping box, and the insects are forced to climb toward the division plate so as to be adhered by the adhesive in the interior area after entry, achieving an insect killing effect.

In one embodiment, the bottom of the exterior area and the side wall close to the exterior area of the division plate are also provided with the smoothing agent. With the abovementioned structure, as the inner surface of the side wall of the trapping box, the bottom of the exterior area and the side wall close to the exterior area of the division plate are smooth, insects are forced to climb toward the division plate and then climb into the interior area, achieving a better insect killing effect.

In one embodiment, the smoothing agent is selected from one or two or more of talcum powder, Polytetrafluoroethylen and diatomite.

In one embodiment, the height of the division plate is lower than the height of the side wall of the trapping box. With the abovementioned structure, insects are enabled to climb into the interior area easily.

In one embodiment, an attractant is mixed in the adhesive. With the abovementioned structure, the attractant plays a role in luring insects to climb into the interior area.

In one embodiment, the trap comprises a housing with an accommodating cavity; a controller is mounted in the housing; the accommodating cavity is internally provided with a carbon dioxide generator that operates under the control of the controller. A through hole is formed in the lower wall of the housing and above the trapping box. An air outlet of the carbon dioxide generator is communicated with the through hole via a conduit. With the abovementioned structure, carbon dioxide generated by the carbon dioxide generator is introduced into the trapping box via the conduit. A better luring effect is achieved since insects prefer dense carbon dioxide.

In one embodiment, the lower wall of the trap is provided with a heating sheet that works under the control of the controller. In the above structure, the heating sheet is served as a heat source to improve the temperature nearby the trapping box so as to create a pleasant environment for the insects, with a better insect luring effect.

In one embodiment, the lower wall of the trap protrudes out toward the trapping box to form a boss, and the heating sheet is mounted on the lower end surface of the boss. By adopting this structure, the heating sheet is closer to the trapping box so as to provide a better heating effect.

In one embodiment, the boss is provided with a cavity with an opening at the upper end and a heat-insulating part is arranged in the cavity. With the abovementioned structure, the heat-insulating part insulates the heat generated by the heating sheet so as to avoid influencing other components in the housing by the heat generated by the heating sheet.

In one embodiment, a baffle is arranged at the cavity bottom of the accommodating cavity, which blocks the opening of the cavity. With the abovementioned structure, the baffle covers the opening of the cavity to seal the heat-insulating part, electric wires and the like within the cavity, thereby making interior of the housing tidy, and better user experience can be anticipated.

### BRIEF DESCRIPTION OF THE DRAWINGS

FIG. 1 is a schematic diagram of the three-dimensional structure of an insect trap of the present disclosure.

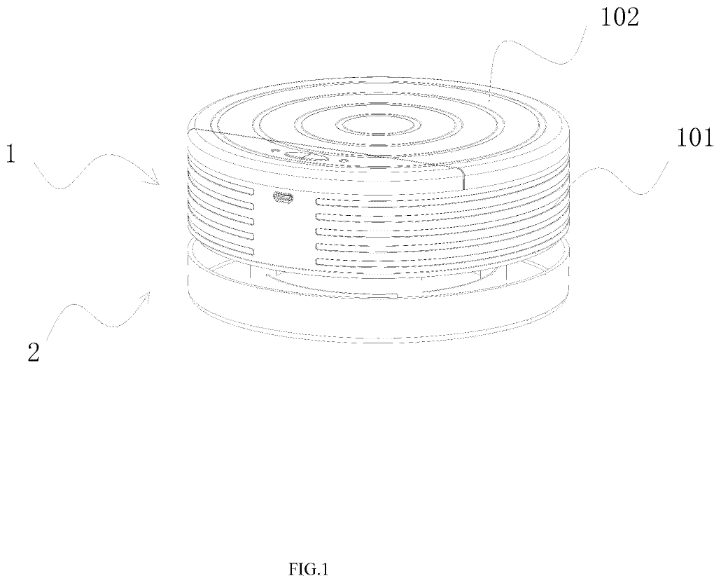

FIG. 2 is a schematic diagram of an exploded structure of the insect trap of the present disclosure.

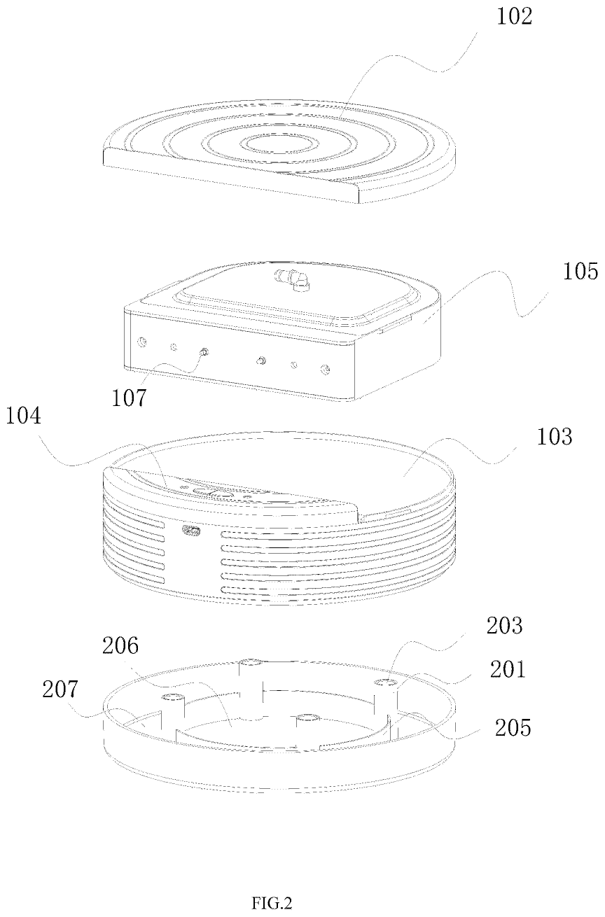

FIG. 3 is a section view of the insect trap of the present disclosure.

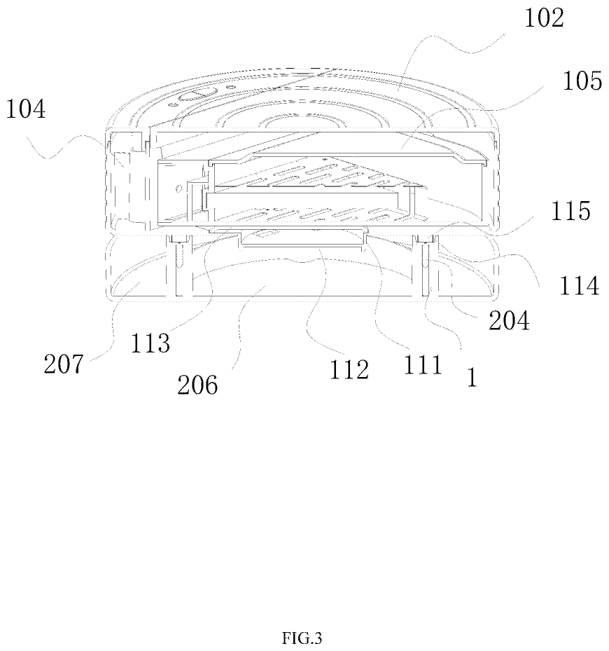

FIG. 4 is a schematic diagram of the three-dimensional structure of the insect trap of the present disclosure, with the cover removed.

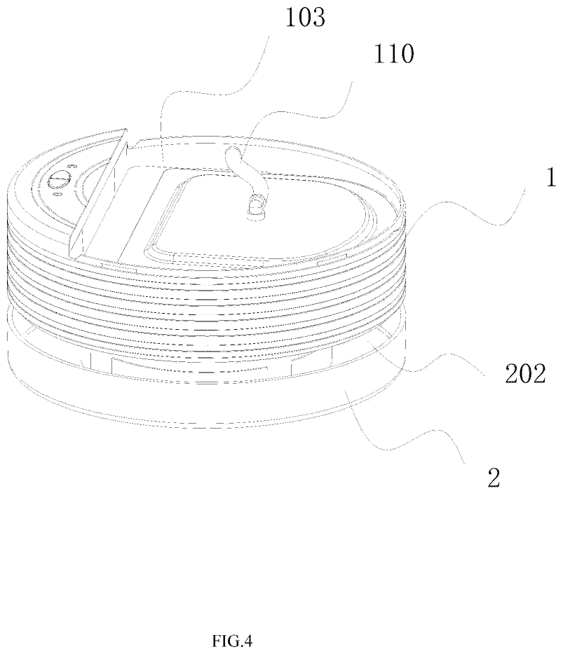

FIG. 5 is a schematic diagram of the three-dimensional structure of the housing and the carbon dioxide generator of the insect trap of the present disclosure.

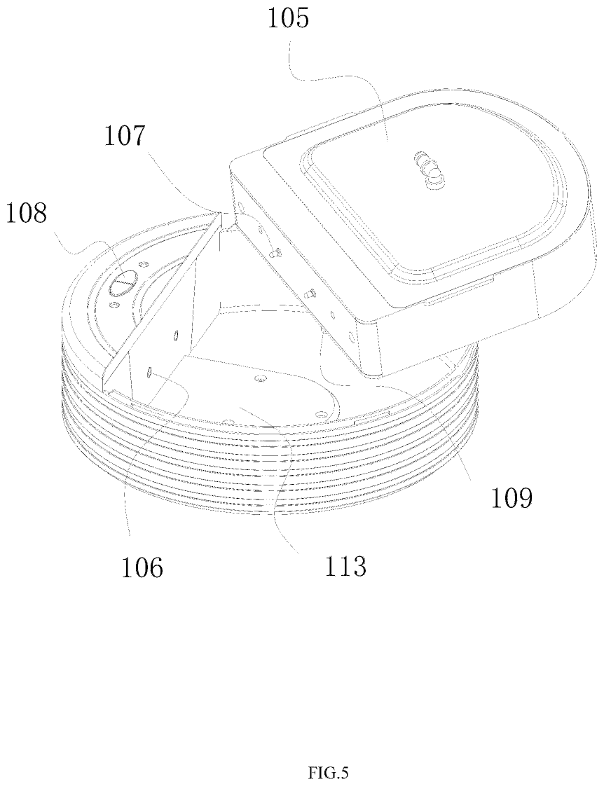

### REFERENCE NUMERALS

1 trap; 101 housing; 102 cover; 103 accommodating cavity; 104 control box; 105 carbon dioxide generator; 106 contact; 107 elastic contact; 108 switch button; 109 through hole; 110 conduit; 111 boss; 112 heating sheet; 113 baffle; 114 bulge; 115 magnet; 2 trapping box; 201 connecting column; 202 space; 203 groove; 204 bolt; 205 division plate; 206 interior area; 207 exterior area.

### EMBODIMENTS

Various aspects of the illustrative embodiments of the present disclosure will be described herein using terms commonly employed by those skilled in the art. However, it will be apparent to those skilled in the art that alternate embodiments may be practiced with only some of the described aspects. For purposes of explanation, specific numbers, materials and configurations are set forth in order to provide a thorough understanding of the illustrative embodiments. It will be apparent that alternate embodiments may be practiced without the specific details. In other instances, well-known features are omitted or simplified in order not to obscure the illustrative embodiments.

It should be further understood that, the wordings “comprising”, “including”, “having”, “comprise” and “containing”, when used to represent existence of features, integrals, steps, operations, elements and/or components in the description, are not intended to be interpreted as excluding the existence or addition of one or more of other features, integrals, steps, operations, elements, components or combinations thereof. Besides, when such words as “ . . . at least one” follow a list in which features are contained, they are used to modify the whole listed features rather than a single one in the list.

The insect trap in the present disclosure comprises a trap 1 and a trapping box 2.

The trap 1 comprises a housing 101 with an accommodating cavity 103; the housing 101 is provided with a cover 102 buckled on the housing 101 for covering the accommodating cavity 103. The housing 101 is internally provided with a control box 104 and a controller is provided inside the control box 104. A carbon dioxide generator 105 is arranged in the accommodating cavity 103, and as it falls into the scope of the prior art, any description about it is not provided hereby to avoid repetition. The side wall of the control box 104 is provided with a contact 106, which is electrically connected with the controller; the housing of the carbon dioxide generator 105 is provided with an elastic contact 107; the elastic contact 107 is compressed and abut against the contacts 106 after the carbon dioxide generator 105 is mounted in the accommodating cavity 103, so that the inner circuit of the carbon dioxide generator 105 is conducted, and the carbon dioxide generator 105 operates under the control of the controller. A switch button 108 connected with the controller, is located on the outer wall of the control box 104 for turning on or off the controller.

An air outlet is formed in the housing of the carbon dioxide generator 105. At the cavity bottom of the accommodating cavity 103, a through hole 109 is formed in the housing 101; the air outlet is communicated with the through hole 109 via a conduit 110; the carbon dioxide released by the carbon dioxide generator 105 is guided out of the housing 101 via the conduit 110.

The lower wall of the housing 101 (i.e., the cavity bottom of the accommodating cavity 103) protrudes downwards to from a boss 111 that has a cavity with an opening at the upper end; the cavity is communicated with the accommodating cavity 103. A heating sheet 112 is provided at the lower end surface of the boss 111 and the heating sheet 112 is a ceramic heating sheet. The heating sheet 112 is connected with a lead that runs through the side wall of the boss 111 and penetrates through the cavity to be electrically connected with the controller in the control box 104. The cavity is internally provided with a heat-insulating part (not shown). The cavity bottom of the accommodating cavity 103 is provided with a baffle 113 that is buckled on the bottom of the accommodating cavity 103 for blocking the opening of the cavity. A passage (not shown) for the lead to pass through is reserved between the baffle 113 and the bottom of the accommodating cavity 103 so that the lead in the cavity passes through the passage and enters into the control box 104.

An opening is provided at the upper end of the trapping box 2. In the middle of the bottom of the trapping box 2 is provided with a connecting piece. In this embodiment, the connecting piece is a connecting column 201, and four connecting columns 201 are arranged and distributed evenly in the middle of the bottom of the trapping box 2. The height of the connecting column 201 exceeds the height of the trapping box 2. Besides, the connecting column 201 is detachably connected on the lower surface of the trap 1. A space 202 for insects to pass through is reserved between the upper edge of the side wall of the trapping box 2 and the trap 1, that is to say, under the effect of the connecting pieces, the distance between the side wall of the trapping box 2 and the lower surface of the trap 1 is broadened, so that insects are prevented from climbing onto the trap 1 along the trapping box 2 but to climb into the trapping box 2. The through hole 109 is located above the trapping box 2, and the trapping box 2 is filled with the carbon dioxide discharged from the through hole 109.

The upper end surface of the connecting column 201 is provided with a groove 203, whereas the lower surface of the trap 1 is provided with a bulge 114. The bulge 114 is clamped into the groove 203. The groove bottom of each groove 203 is fixedly connected with a bolt 204. The nut of the bolt 204 is exposed within the groove 203. A magnet 115 is arranged at the lower end surface of the bulge 114. When the bulge 114 is clamped in the groove 203, the magnet 115 is adsorbed onto the nut of the bolt 204. The bolt can be replaced with an iron sheet or a magnet. In case of mounting a magnet in the groove, an iron sheet can also be mounted on the bulge as long as the two attract each other.

The bottom of the trapping box 2 is provided with a circle of closed division plate 205 that divides the trapping box 2 into an interior area 206 and an exterior area 207. In this embodiment, the division plate 205 is connected between two adjacent connecting columns 201. The division plate 205 and the connecting columns 201 are connected in an end-to-end manner to form a closed ring. Still in this embodiment, the trapping box 2 is of circular shape, and the side wall of the trapping box 2 is of annular shape. The height of the division plate 205 is lower than the height of the side wall of the trapping box 2. The interior area 206 is located right below the heating sheet 112. An adhesive (not shown) is arranged in the interior area 206, and the adhesive is mixed with an attractant. The inner surface of the side wall of the trapping box 2, the bottom of the exterior area, the side wall close to the exterior area of the division plate and the side walls of the connecting columns are respectively coated with a smoothing agent (not shown). The smoothing agent is selected from one or two or more of talcum powder, Polytetrafluoroethylen and diatomite.

The adhesive and the attractant form a killing component, which can be added or replaced with other structures, such as an electric net.

When the insect trap operates, turn on the switch button 108, and the controller controls the carbon dioxide generator 105 and the heating sheet 112 to operate; then the carbon dioxide released by the carbon dioxide generator 105 is introduced in the trapping box 2 via the conduit 110; under the joint effect of the carbon dioxide and the heating sheet 112, lured by the attractant in the interior area 206, insects will climb into the trapping box 2 along the outside wall of the trapping box 2; since the exterior area 207 is coated with a smoothing agent, making it difficult for the insects to climb out of the trapping box 2 but to move toward the interior area 206, and further be adhered by the adhesive in the interior area 206 until dead. With a good insect killing effect, the insect trap can also be applied for killing mosquitoes or flies.

Although certain embodiments have been illustrated and described herein for purposes of description, a wide variety of alternate and/or equivalent embodiments or implementations calculated to achieve the same purposes may be substituted for the embodiments shown and described without departing from the scope of present disclosure. This application is intended to cover any adaptations or variations of the embodiments discussed herein. Therefore, it is manifestly intended that embodiments described herein be limited only by the claims and the equivalents thereof.

1. An insect trap, comprising a trap and a trapping box with an opening at the upper end; the trapping box is internally provided with a killing component wherein the trapping box is mounted underneath the trap and the bottom of the trapping box is connected to the trap; a space for insects to pass through is reserved between the trap and the upper edge of the trapping box.

2. The insect trap of claim 1, wherein a connecting piece is provided on the inner wall of the bottom of trapping box, the height of the connecting piece exceeding the height of the trapping box and the connecting piece is detachably connected to the lower surface of the trap.

3. The insect trap of claim 2, wherein the upper end surfaces of the connecting piece and the lower surface of the trap are clamped by means of a groove and a bulge.

4. The insect trap of claim 3, wherein the upper end surface of the connecting piece is provided with the said groove and the lower surface of the trap is provided with the said bulge.

5. The insect trap of claim 3, wherein the groove is internally provided with a first adsorptive piece that can be an iron piece or a magnet; the bulge is provided with a second adsorptive piece that can be a magnet or an iron piece; the bulge is clamped into the groove and the first and second adsorptive pieces attract.

6. The insect trap of claim 5, wherein the groove bottom of the groove is fixedly connected with a bolt, and the lower surface of the bulge is fixedly connected with a magnet.

7. The insect trap of claim 2, wherein the bottom of the trapping box is provided with a circle of closed division plate that divides the trapping box into an interior area and an exterior area; the interior area is provided with an adhesive and the inner surface of the side wall of the trapping box is arrange with a smoothing agent.

8. The insect trap of claim 7, wherein the bottom of the exterior area and the side wall close to the exterior area of the division plate are also provided with the smoothing agent.

9. The insect trap of claim 8, wherein the smoothing agent is selected from one or two or more of talcum powder, Polytetrafluoroethylen and diatomite.

10. The insect trap of claim 7, wherein the height of the division plate is lower than the height of the side wall of the trapping box.

11. The insect trap of claim 7, wherein an attractant is mixed in the adhesive.

12. The insect trap of claim 1, wherein the trap comprises a housing with an accommodating cavity; a controller is mounted in the housing; the accommodating cavity is internally provided with a carbon dioxide generator that operates under the control of the controller; a through hole is formed in the lower wall of the housing and above the trapping box; an air outlet of the carbon dioxide generator is communicated with the through hole via a conduit.

13. The insect trap of claim 12, wherein the lower wall of the trap is provided with a heating sheet that works under the control of the controller.

14. The insect trap of claim 13, wherein the lower wall of the trap protrudes out toward the trapping box to form a boss, and the heating sheet is mounted on the lower end surface of the boss.

15. The insect trap of claim 14, wherein the boss is provided with a cavity with an opening at the upper end and a heat-insulating part is arranged in the cavity.

16. The insect trap of claim 15, wherein a baffle is arranged at the cavity bottom of the accommodating cavity; the baffle blocks the opening of the cavity.

17. The insect trap of claim 2, wherein the trap comprises a housing with an accommodating cavity; a controller is mounted in the housing; the accommodating cavity is internally provided with a carbon dioxide generator that operates under the control of the controller; a through hole is formed in the lower wall of the housing and above the trapping box; an air outlet of the carbon dioxide generator is communicated with the through hole via a conduit.

18. The insect trap of claim 3, wherein the trap comprises a housing with an accommodating cavity; a controller is mounted in the housing; the accommodating cavity is internally provided with a carbon dioxide generator that operates under the control of the controller; a through hole is formed in the lower wall of the housing and above the trapping box; an air outlet of the carbon dioxide generator is communicated with the through hole via a conduit.

19. The insect trap of claim 5, wherein the trap comprises a housing with an accommodating cavity; a controller is mounted in the housing; the accommodating cavity is internally provided with a carbon dioxide generator that operates under the control of the controller; a through hole is formed in the lower wall of the housing and above the trapping box; an air outlet of the carbon dioxide generator is communicated with the through hole via a conduit.

20. The insect trap of claim 7, wherein the trap comprises a housing with an accommodating cavity; a controller is mounted in the housing; the accommodating cavity is internally provided with a carbon dioxide generator that operates under the control of the controller; a through hole is formed in the lower wall of the housing and above the trapping box; an air outlet of the carbon dioxide generator is communicated with the through hole via a conduit.
